(19) United States
(12) Patent Application Publication
(10) Pub. No.: US 2025/0053308 A1
(43) Pub. Date: Feb. 13, 2025

(54) DIRTY BLOCK MAP TRACKER FOR PRIMARY-SECONDARY MEMORY DEVICES IN DISAGGREGATED MEMORY SYSTEMS

(71) Applicant: International Business Machines Corporation, Armonk, NY (US)

(72) Inventors: Onkar PATIL, San Jose, CA (US); Saransh GUPTA, San Jose, CA (US); Swaminathan SUNDARARAMAN, San Jose, CA (US)

(21) Appl. No.: 18/446,011

(22) Filed: Aug. 8, 2023

(51) Int. Cl. G06F 3/06

(52) U.S. Cl. CPC G06F 3/0619; G06F 3/065; G06F 3/0683

(57) ABSTRACT

Techniques for computer memory synchronization are disclosed. These techniques include triggering synchronization between a first memory controller and a second memory controller, wherein the first memory controller is associated with a first memory device and a first computer processor, and wherein the second memory controller is associated with a second memory device and a second computer processor. The techniques further include transmitting a dirty block map, based on the triggering, from the first memory controller to the second memory controller, wherein the dirty block map identifies one or more dirty memory blocks, from among a plurality of memory blocks, associated with the first memory controller. The techniques further include copying the one or more dirty memory blocks from the first memory device to the second memory device based on the dirty block map.

### BACKGROUND

The present invention relates to computer architecture, and more specifically, to computer memory systems.

### SUMMARY

Embodiments include a method. The method includes triggering synchronization between a first memory controller and a second memory controller, wherein the first memory controller is associated with a first memory device and a first computer processor, and wherein the second memory controller is associated with a second memory device and a second computer processor. The method further includes, based on the triggering, transmitting a dirty block map from the first memory controller to the second memory controller, wherein the dirty block map identifies one or more dirty memory blocks, from among a plurality of memory blocks, associated with the first memory controller. The method further includes copying the one or more dirty memory blocks from the first memory device to the second memory device based on the dirty block map.

Embodiments further include a system. The system includes a first memory controller associated with a first memory device and a first computer processor. The system further includes a second memory controller associated with a second memory device and a second computer processor. The system further includes a memory having instructions stored thereon which, when executed by one or more of the first memory controller, the first computer processor, the second memory controller, or the second computer processor, performs operations. The operations include triggering synchronization between the first memory controller and the second memory controller. The operations further include based on the triggering, transmitting a dirty block map from the first memory controller to the second memory controller, wherein the dirty block map identifies one or more dirty memory blocks, from among a plurality of memory blocks, associated with the first memory controller. The operations further include copying the one or more dirty memory blocks from the first memory device to the second memory device based on the dirty block map.

Embodiments further include a computer program product including a computer-readable storage medium having computer-readable program code embodied therewith, the computer-readable program code executable by one or more computer processors to perform operations. The operations include triggering synchronization between a first memory controller and a second memory controller, wherein the first memory controller is associated with a first memory device and a first computer processor, and wherein the second memory controller is associated with a second memory device and a second computer processor. The operations further include, based on the triggering, transmitting a dirty block map from the first memory controller to the second memory controller, wherein the dirty block map identifies one or more dirty memory blocks, from among a plurality of memory blocks, associated with the first memory controller. The operations further include copying the one or more dirty memory blocks from the first memory device to the second memory device based on the dirty block map.

### BRIEF DESCRIPTION OF THE DRAWINGS

FIG. 1 illustrates a computing environment for memory synchronization using dirty block map tracking, according to one embodiment.

FIGS. 2A-B illustrate dirty block map tracking for memory synchronization, according to one embodiment.

FIG. 3 is a flowchart illustrating memory synchronization using dirty block map tracking, according to one embodiment.

FIG. 4 is a flowchart illustrating an example signaling mechanism for memory synchronization using dirty block map tracking, according to one embodiment.

FIG. 5 is a flowchart illustrating a health check for memory backup using dirty block map tracking, according to one embodiment.

### DETAILED DESCRIPTION

Memory controllers traditionally have performed the task of fetching data bits from and writing them back to their physical memory locations with limited insight into the data itself. For example, the fetching and writing back of data bits can be carried out on a request or command of the compute unit (e.g., a CPU) which executes the memory operation commands (e.g., based on executing a software program). The memory pipeline includes load and store commands as part of a communication protocol standard between a CPU and its memory controller.

Computing architecture is rapidly changing, however, with multiple processors and accelerators becoming common in modern day computing systems. The scale of computing systems has increased over the decades as well, driven by the constantly rising size of the datasets that are processed on them. In this kind of architecture, every processor can be paired with its own memory device and memory controller. Data processing and memory operations that are carried out in the system are originated at the CPU and then communicated to the respective memory controller to fulfill the operations.

However, new technologies aim to change how we design and use computing systems. For example, compute express link (CXL) is an emerging industry interconnect standard. CXL has many features that make it different from, and potentially more powerful than, prior interconnect protocols (e.g., like peripheral component interconnect express (PCIe) 6 (PCIe-6)). As one example, CXL allows for coherent accesses, in which memory load and store operations are performed over CXL. This expands the possibilities for computer architecture, because the architect is no longer restricted by prior monolithically designed systems and can instead implement disaggregated memory systems (e.g., where memory and compute can be independently scaled using a cache coherent protocol like CXL). CXL is merely one example, and a variety of suitable interconnect protocols can be used (e.g., a Gen-Z protocol, an Open Coherent Accelerator Processor Interface (CAPI) protocol, a cache coherent interconnect for accelerators (CCIX) protocol, another cache coherent interconnect protocol, or any other suitable interconnect protocol).

With the massive amounts of data that is processed in the computing systems having so many varied compute and memory components, the availability and consistency of the data is critical. This is more important now as the increase in the number and complexity of the components results in more frequent device failures and software. These computing systems could benefit from having redundant copies of the data and the corresponding memory devices they are stored on, to ensure the availability and protection of the data. Many modern enterprise-grade systems implement such backup schemes. However, existing techniques typically rely on either explicit data management by the user or a protection-conscious software development. Modern systems instead would benefit from mechanisms that can provide data availability and protection without the user having to bear the burden of implementing them. One or more techniques described herein enable data availability and protection by taking advantage of the capabilities of modern interconnect protocols (e.g., like CXL, a Gen-Z protocol, an Open CAPI protocol, a CCIX protocol, another cache coherent interconnect protocol, or any other suitable interconnect protocol).

In an embodiment, one or more techniques described herein facilitate and accelerate data availability and protection by avoiding CPU intervention to perform a memory synchronization operation between devices that can communicate with each other. For example, this can be done with two elements. First, in an embodiment, a “dirty block map” can be used to track modified blocks for various memory controllers. In addition, or alternatively, a signaling mechanism between memory controllers can be used to communicate the predefined dirty block maps. These techniques can reduce the amount of data transfers needed to implement data reliability and high-availability mechanisms and relieve the CPU from involvement in this operation. In an embodiment, one or more of these techniques can be implemented as a completely hardware (HW) solution, a completely software (SW) solution (e.g., leveraging CXL or another interconnect protocol), or as part of a HW-SW co-design.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

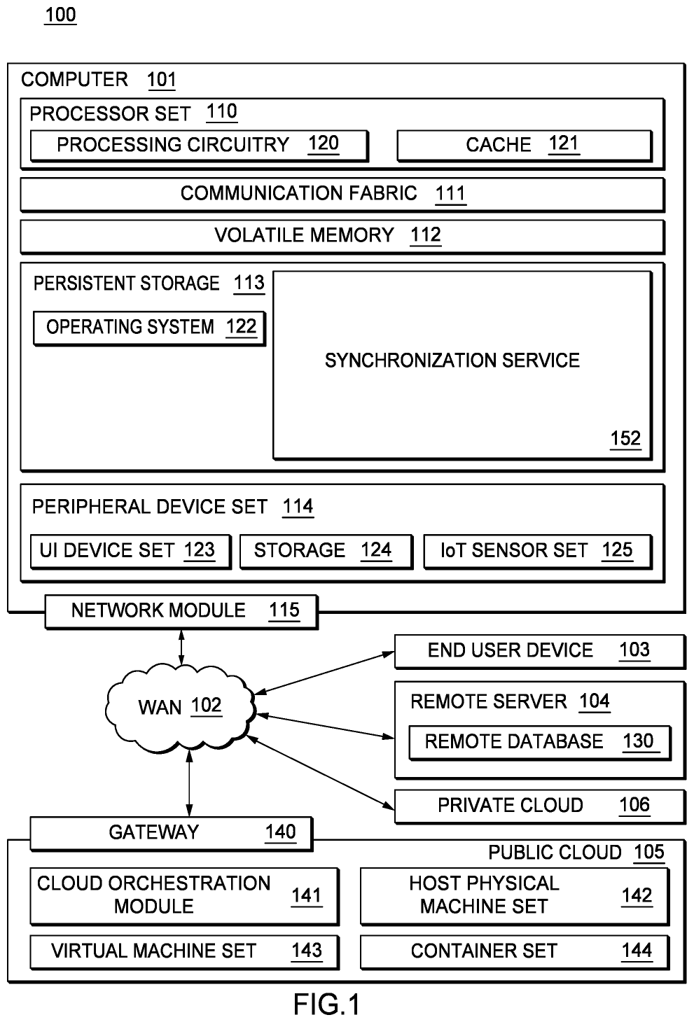

FIG. 1 illustrates a computing environment 100 for memory synchronization using dirty block map tracking, according to one embodiment. Computing environment 100 contains an example of an environment for the execution of at least some of the computer code involved in performing the inventive methods, such as synchronization service 152 for memory synchronization using dirty block map tracking. In addition to block 152, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 152, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 152 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 152 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

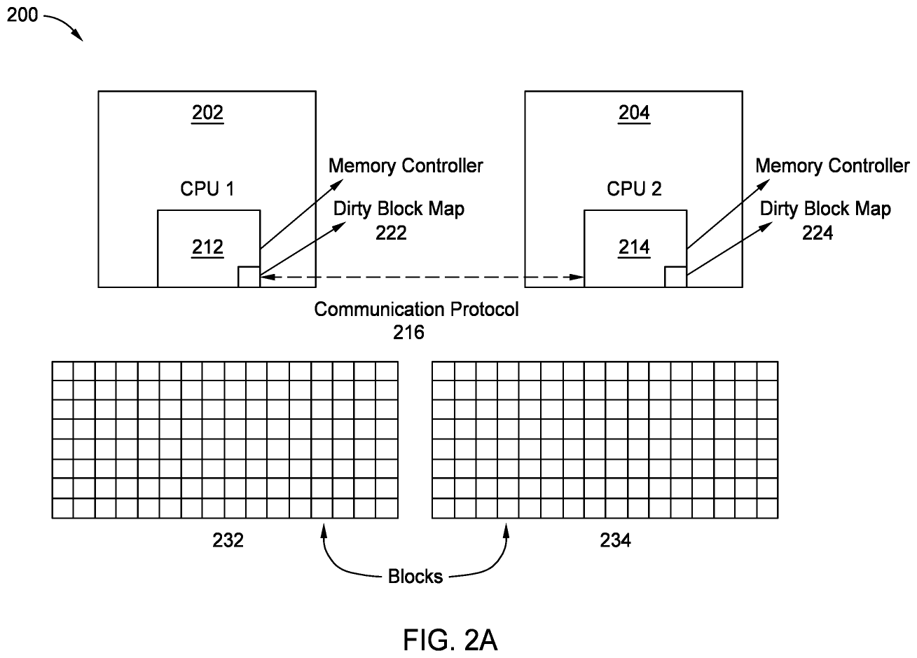

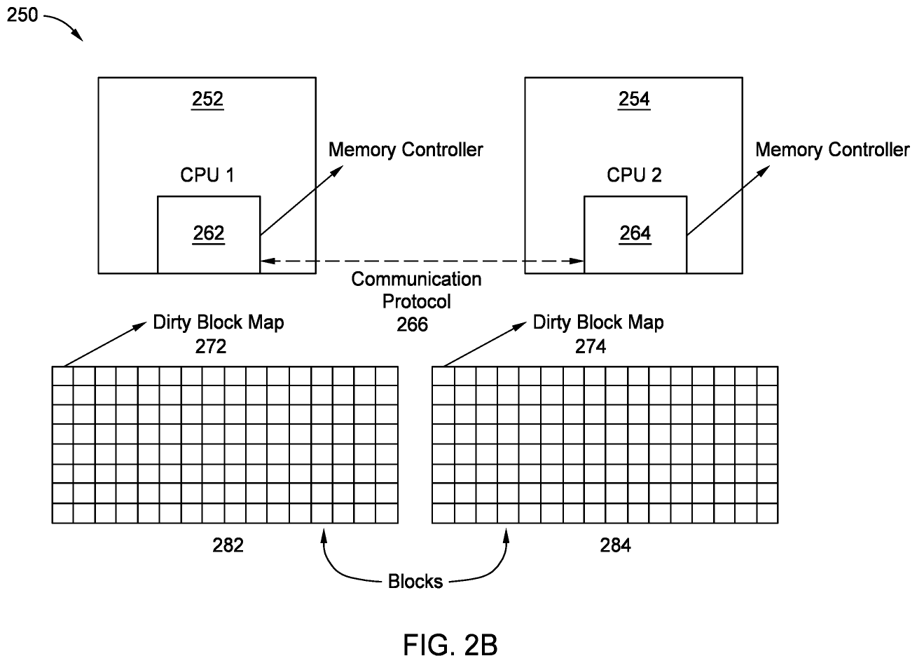

FIGS. 2A-B illustrate dirty block map tracking for memory synchronization, according to one embodiment. FIG. 2A illustrates a computing system 200 with multiple processors, each with its own memory controller. For example, a first CPU 202 includes a first memory controller 212. A second CPU 204 includes a second memory controller 214. In an embodiment, the memory controllers 212 and 214 manage communication between the respective processors 202 and 214, and memory devices (e.g., dynamic random access memory (DRAM)) 232 and 234. DRAM is merely one example, and the memory devices 232 and 234 can be any suitable volatile, or non-volatile, memory (e.g., any suitable RAM, flash memory, magnetic disk, or any other suitable type of memory).

A synchronization service (e.g., the synchronization service 152 illustrated in FIG. 1) can be used with a dirty block map (DBM) memory address buffer. In an embodiment, the DBM contains a bit corresponding to each physical page or cacheline on the respectively attached memory devices, and indicates whether the respective block has been modified. For example, a DBM 222 is associated with the memory device 232 and the DBM 224 is associated with the memory device 234. In an embodiment, as discussed further below, the memory device 234 acts as a backup for the memory device 232 and so the DBMs 222 and 224 each reflect modification of blocks in the memory devices.

In one embodiment, the DBM resides in the memory controller. This is illustrated in FIG. 2A, where the DBM 222 resides in the memory controller 212 and the DBM 224 resides in the DBM 224. Alternatively, the DBM resides in the memory device itself. This is illustrated below with regard to FIG. 2B. For example, where CPU memory is premium or having a memory buffer on the memory controller is not feasible, the DBM can reside on the memory device itself.

In an embodiment, the granularity of a block in the DBM can be tailored to the needs of the system. For example, the granularity of the block could be a physical page size of 4 KB. In this instance, if the capacity of each memory device 232 and 234 is 64 GB, respectively, then each DBM will be 16 Mb.

In an embodiment, the synchronization service uses each DBM 222 and 224 to track blocks that are being written to the memory devices 232 and 234 by the processors 202 and 204. When a write request arrives at a memory controller 212 or 214, the synchronization service changes the mapped bit (e.g., changes the value of the bit to either 0 or 1 to indicate that the block has been updated) in the DBM corresponding to the physical block where the memory address of the write request resides.

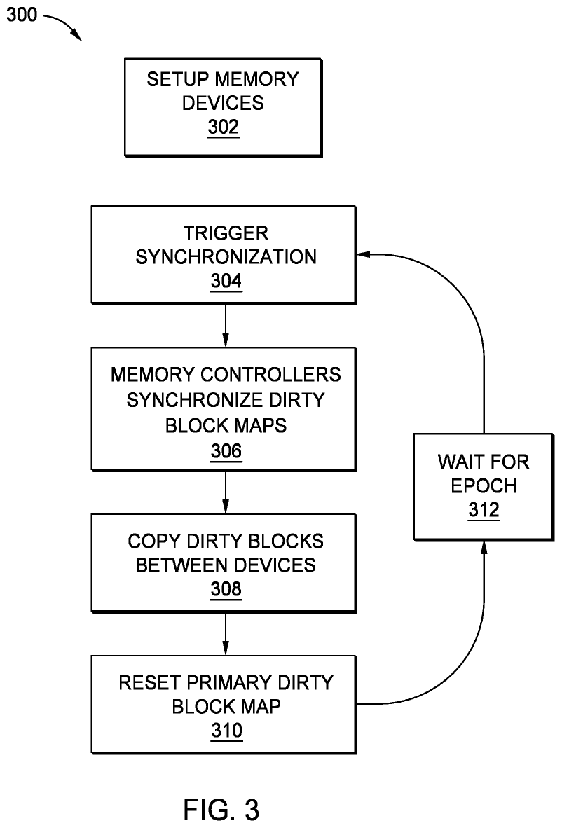

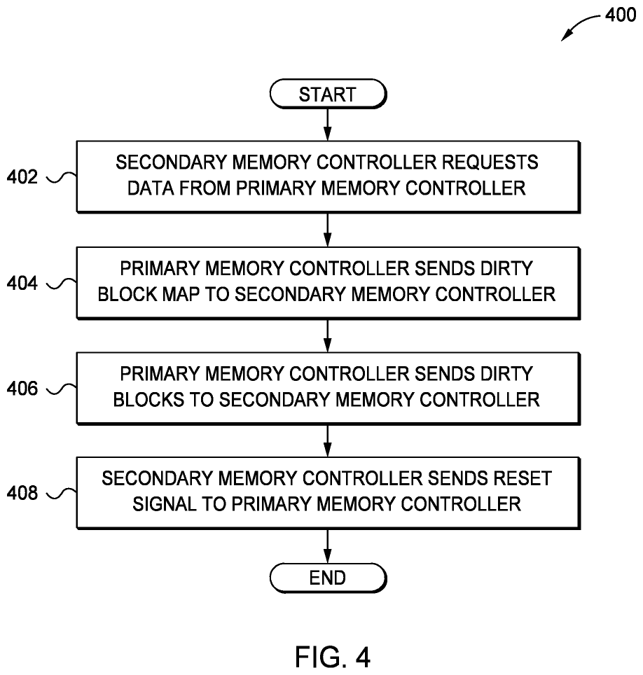

In an embodiment, the mapping of each bit in the DBM 222 or 224 to its corresponding physical block in the attached memory device 232 or 234 can be resolved by a simple bitwise operation. For example, a synchronization service could use a 1-1 mapping, in which bit-n of the respective DBM 222 or 224 corresponds to block-n in the memory device 232 or 234. In one embodiment, the DBM 222 and 224 is a hardware memory buffer added to the memory controller 212 and 214, which is on the CPU package 202 and 204. This is illustrated in FIG. 2A. Alternatively, or in addition, the synchronization service can implement a software implementation in which the DBM could borrow the required capacity from the memory device itself. This is illustrated in FIG. 2B. This synchronization is discussed further, below, with regard to FIGS. 3-4.

In an embodiment, the memory controllers 212 and 214 communicate using a communication protocol 216. For example, a suitable interconnect protocol can be used (e.g., CXL, a Gen-Z protocol, an Open CAPI protocol, a CCIX protocol, another cache coherent interconnect protocol, or any other suitable interconnect protocol). For example, communication between the memory controllers 212 and 214 can be triggered by a processor instruction (e.g., from one or both of the CPUs 212 and 214), and then the data exchange can involve only the memory controllers 212 and 214 (e.g., the CPUs 212 and 214 trigger the data exchange but then are not involved in the exchange). As another example, the memory controllers 212 and 214 can trigger communication using the communication protocol 216, themselves (e.g., using CXL 3.0 or another suitable interconnect protocol). Similarly, a suitable software service (e.g., the synchronization service) can synchronize the memory devices over CXL without CPU intervention. These are merely examples, and any suitable technique can be used (e.g., any suitable interconnect protocol can be used, including a Gen-Z protocol, an Open CAPI protocol, a CCIX protocol, another cache coherent interconnect protocol, or any other suitable interconnect protocol).

FIG. 2B illustrates a computing system 250. In an embodiment, FIG. 2B is similar to FIG. 2A, except the DBM is maintained in the memory devices themselves rather than in the memory controller. The computing system 250 includes a first CPU 252 with a first memory controller 262, and a second CPU 254 with a second memory controller 264. Just as for the computing system 200 illustrated in FIG. 2A, in an embodiment the memory controllers 262 and 264 manage communication between the respective processors 252 and 254, and memory devices (e.g., DRAM) 282 and 284. DRAM is merely one example, and the memory devices 282 and 284 can be any suitable volatile, or non-volatile, memory (e.g., any suitable RAM, flash memory, magnetic disk, or any other suitable type of memory).

A synchronization service (e.g., the synchronization service 152 illustrated in FIG. 1) can be used with a DBM memory address buffer. In an embodiment, the DBM contains a bit corresponding to each physical page or cacheline on the respectively attached memory devices. For example, a DBM 272 is associated with the memory device 282 and the DBM 254 is associated with the memory device 284.

In the computing system 250, each DBM resides in the memory device itself. For example, the DBM 272 resides in the memory device 282. The DBM 274 resides in the memory device 284. A synchronization service (e.g., the synchronization service 152 illustrated in FIG. 1) coordinates mapping between each DBM 272 and 274 and the corresponding memory devices 282 and 284. This synchronization is discussed further, below, with regard to FIGS. 3-4.

In an embodiment, the memory controllers 262 and 264 communicate using a communication protocol 266. For example, a suitable interconnect protocol can be used (e.g., CXL). Just as for the communication protocol 216 discussed above in relation to FIG. 2A, communication can be triggered by a processor instruction, the memory controllers, a suitable software service, or using any other technique.

FIG. 3 is a flowchart 300 illustrating memory synchronization using dirty block map tracking, according to one embodiment. At block 302, an administrator (e.g., a human or automated administrator) sets up memory devices. For example, before booting up a computing system (e.g., in a basic input/output system (BIOS)), an administrator can set up two memory devices connected to separate memory controllers as active and backup devices for the purpose of making the system resilient to errors and crashes. In an embodiment, denoting a memory device as a backup or replica (e.g., in the BIOS) entails a primary-secondary relationship where write and read memory requests from the processor can be served only by the primary memory device and no requests are served by the secondary memory device to the processor. For this purpose, an advanced configuration and power interface (ACPI) mapping table may be added as part of the BIOS. This table will maintain the state of the primary-secondary relationship of the memory devices. For software implementations, a kernel may also interact with this table.

At block 304, a suitable hardware or software element triggers synchronization. For example, a processor can send a trigger instruction or command. As discussed above in relation to FIGS. 2A-B, a processor is merely one example of a suitable element to trigger synchronization. A memory controller, a suitable software service, or any other suitable element can trigger synchronization.

At block 306, the memory controllers synchronize DBMs. In an embodiment, the memory controller of the primary memory device syncs up with the memory controller of the secondary memory device to update the corresponding DBM. The copying instructions are a part of the signaling mechanism between the memory controllers. For example, the memory controllers can use the communication protocol 216 discussed above in relation to FIG. 2A, the communication protocol 266 discussed above in relation to FIG. 2B, or any other suitable communication technique.

At block 308, the memory controllers copy dirty blocks between devices. For example, the secondary memory controller can use the information stored in the DBM to copy the dirty blocks (e.g., modified blocks) from the primary memory device to the secondary memory device. In an embodiment, the blocks are copied without the intervention of the processor (e.g., during the process of updating the DBM of the secondary device and copying dirty blocks, the processor does not issue any memory read or write operations).

At block 310, the hardware or software controller (e.g., the hardware or software implementation as discussed above in relation to FIGS. 2A-B) resets the DBM. In an embodiment, after all the dirty blocks are copied, the DBM of the primary memory device is reset. For a software implementation, the signaling mechanism can be implemented as a separate kernel module, given that the DBM is exposed to the software as a separate memory block in the kernel but protected from user-space accesses.

At block 312, the hardware or software controller waits for an epoch. In an embodiment, updating of the DBM can happen at every epoch based on the number of memory requests, a certain timeframe, or any other suitable factor. For example, the DBM can be updated every time a threshold number of memory requests occurs (e.g., 10000 memory requests), every time a threshold time period passes (e.g., 100 ms), or at any other suitable interval.

In an embodiment, the techniques discussed above in relation to FIG. 3 can be used for replication, snapshotting, checkpointing, memory transfer, or any other suitable purpose. One or more of these techniques has many advantages. For example, using one or more of these techniques can reduce memory traffic for data write requests in all the above-mentioned use cases and relieving the processor from wasting compute cycles.

As another example, the DBM state after every epoch can be maintained as a log of the state of the memory device (e.g., the state of a dual in-line memory module (DIMM) or another suitable form of random access memory (RAM) or other suitable memory). This can allow for rollback in the case of data corruption in the memory device (e.g., in the DIMM). As a further example, the DBM can be used for selective memory mirroring by using customized block sizes, epochs, or both, for different workloads.

FIG. 4 is a flowchart 400 illustrating an example signaling mechanism for memory synchronization using dirty block map tracking, according to one embodiment. In an embodiment, any suitable signaling mechanism can be used to implement the techniques described in FIG. 3. For example, a signaling mechanism could be based on {addr, data} pairs to mimic memory transactions. Two memory-mapped registers (addr_DBM, addr_reset) can be introduced to the memory controller. Like the DBM illustrated in FIGS. 2A-B, these two registers can reside either at the memory controllers or as part of a memory region carved out of the main memory space. Values written to these registers act as control signals, enabling DBM request and allowing reset after synchrosnization.

At block 402, a secondary memory controller (sMC) requests data from a primary memory controller (pMC). In an embodiment, an sMC can start by synchronizing the DBM from the pMC. For example, the sMC could initiate a memory transaction {addr_DBM, 1}, where add_DBM is the DBM address.

At block 404, the pMC sends to the DBM to the sMC. In an embodiment, the pMC responds to the memory transaction initiated by the sMC at block 402 by sending the DBM to the sMS. For example, the pMC could initiate a memory transaction {add_DBM. DBM}.

At block 406, the pMC sends the dirty blocks to the sMC. For example, the pMC can initiate a memory transaction {addr, data}, where the data are the dirty blocks.

At block 408, the sMC sends a reset signal to the pMC. In an embodiment, the dirty blocks have been transferred from the pMC to the sMC and so the DBM should be reset. The sMC can initiate a memory transaction {addr_reset, 1}, representing sync completion. The blocks illustrated in FIG. 4 are merely one example, and any suitable signaling mechanism can be used.

In an embodiment, the above example transactions notify the sMC about the total data transfers it should expect from pMC. This is followed by the actual transfer of data, driven by pMC The pMC only transfers data belonging to the blocks that are set dirty in the DPM. After receiving the expected amount of data, the sMC sends a reset signaling which reset the DPM at the pMC and provides acknowledgement of synchronization completion.

In an embodiment, these memory transaction are implemented using registers that are hard-coded in the memory controller or introduced as part of the firmware by the memory vendor. Alternatively, or in addition, CXL can further enable this signaling mechanism. For example, CXL enables a system architect to put an application-specific integrated circuit (ASIC) between a CXL-enabled memory controller and a CXL-enabled memory device. This ASIC can provide the necessary signal decoding and register mapping required for the signaling mechanism. As another example, the system can include an orchestrator (e.g., a CXL-attached accelerator, co-processor, or compute-engine) that acts as an interface between the two memory controllers. The orchestrator can manage the primary-secondary relationship and handles accesses to addr_DBM and addr_reset registers.

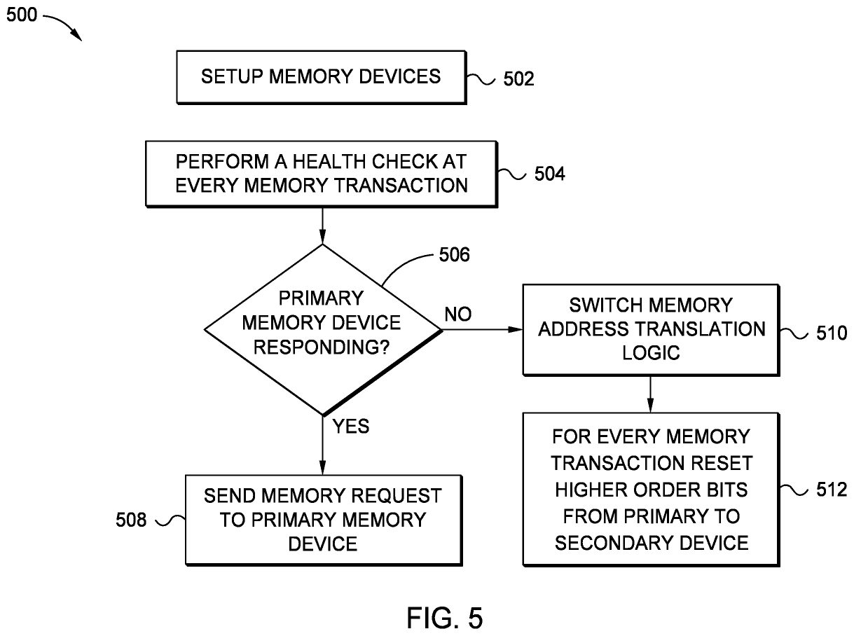

FIG. 5 is a flowchart 500 illustrating a health check for memory backup using dirty block map tracking, according to one embodiment. As discussed above, dirty block map tracking can be used to maintain primary and secondary memory devices where the secondary memory device acts as a backup for data stored in the primary memory device.

At block 502, an administrator (e.g., a human or automated administrator) sets up memory devices. For example, like for block 302 illustrated in FIG. 3, before booting up a computing system (e.g., in a BIOS), an administrator can set up two memory devices connected to separate memory controllers as active and backup devices for the purpose of making the system resilient to errors and crashes. In an embodiment, denoting a memory device as a backup or replica (e.g., in the BIOS) entails a primary-secondary relationship where write and read memory requests from the processor can be served only by the primary memory device and no requests are served by the secondary memory device to the processor. For this purpose, an ACPI mapping table maybe required to added as part of the BIOS. This table will maintain the state of the primary-secondary relationship of the memory devices. For software implementations, a kernel will also interact with this table.

At block 504, a suitable hardware or software synchronization service (e.g., the synchronization service 152 illustrated in FIG. 1) performs a health check at every memory transaction. For example, the synchronization service can check the health of the primary memory device to determine whether a swap to the secondary memory device is necessary. Performing a health check at every memory transaction is merely one example. Alternatively, the synchronization service can perform the health check at any suitable interval (e.g., when a threshold number of transactions have been conducted, periodically based on a timer, or at any other suitable interval).

At block 506, the synchronization service determines whether the primary memory device is responding. For example, the health check initiated at block 504 can attempt to contact the primary memory device to elicit a response. If the primary memory device is responding, the flow proceeds to block 508.

At block 508, the synchronization service (or any other suitable software or hardware service) sends the memory request to the primary memory device. In an embodiment, the primary memory device responds, and so the memory transaction is conducted as usual using the primary memory device.

Returning to block 506, if the primary memory device is not responding, the flow proceeds to block 510. At block 510 the synchronization service switches the memory address translation logic. In an embodiment, the synchronization can swap the memory transaction from the primary memory controller to the secondary memory. For example, at block 512 the synchronization service can reset the higher order bits, for each memory transaction, from the primary memory device to the secondary memory device. This allows the secondary memory device (e.g., the backup device) to seamlessly service the memory transaction (e.g., because the primary memory device is not responding).

While the foregoing is directed to embodiments of the present invention, other and further embodiments of the invention may be devised without departing from the basic scope thereof, and the scope thereof is determined by the claims that follow.

What is claimed is:

1. A method comprising:
triggering synchronization between a first memory controller and a second memory controller,
wherein the first memory controller is associated with a first memory device and a first computer processor, and
wherein the second memory controller is associated with a second memory device and a second computer processor;
based on the triggering, transmitting a dirty block map from the first memory controller to the second memory controller, wherein the dirty block map identifies one or more dirty memory blocks, from among a plurality of memory blocks, associated with the first memory controller; and
copying the one or more dirty memory blocks from the first memory device to the second memory device based on the dirty block map.

2. The method of claim 1,
wherein the first memory device and the second memory device each comprises random access memory (RAM), and
wherein the transmitting the dirty block map from the first memory controller to the second memory controller comprises:
transmitting the dirty block map from the first memory controller to the second memory controller using an interconnect protocol and without using any of the first computer processor or the second computer processor.

3. The method of claim 2, wherein the interconnect protocol comprises at least one of: (i) a compute express link (CXL) protocol, (ii) a Gen-Z protocol, (iii) an Open Coherent Accelerator Processor Interface (CAPI) protocol, or (iv) a cache coherent interconnect for accelerators (CCIX) protocol.

4. The method of claim 2, wherein the copying the one or more dirty memory blocks from the first memory device to the second memory device comprises:
transmitting the one or more dirty memory blocks from the first memory device to the second memory device using the interconnect protocol and without using any of the first computer processor or the second computer processor.

5. The method of claim 1, wherein the triggering synchronization is performed by at least one of the first computer processor or the second computer processor.

6. The method of claim 1, wherein the triggering synchronization is performed by at least one of the first memory controller or the second memory controller.

7. The method of claim 1, further comprising:
transmitting a reset signal from the second memory controller to the first memory controller;
based on receiving the reset signal, resetting the dirty block map at the first memory controller; and
determining that an epoch has passed, and in response triggering a second synchronization between the first memory controller and the second memory controller.

8. The method of claim 7, wherein determining that the epoch has passed comprises at least one of: (i) determining that a threshold number of memory requests have occurred or (ii) determining that a threshold time period has passed.

9. The method of claim 1, wherein the dirty block map is stored in both the first memory controller and the second memory controller.

10. The method of claim 1, wherein the dirty block map is stored in both the first memory device and the second memory device.

11. The method of claim 1, wherein each block of the dirty block map is sized based on a physical page size for the first memory device.

12. The method of claim 1, wherein the first memory controller comprises a primary memory controller and the second memory controller comprises a secondary memory controller relating to the primary memory controller.

13. A system, comprising:
a first memory controller associated with a first memory device and a first computer processor;
a second memory controller associated with a second memory device and a second computer processor; and
a memory having instructions stored thereon which, when executed by one or more of the first memory controller, the first computer processor, the second memory controller, or the second computer processor, performs operations comprising:
triggering synchronization between the first memory controller and the second memory controller;
based on the triggering, transmitting a dirty block map from the first memory controller to the second memory controller, wherein the dirty block map identifies one or more dirty memory blocks, from among a plurality of memory blocks, associated with the first memory controller; and
copying the one or more dirty memory blocks from the first memory device to the second memory device based on the dirty block map.

14. The system of claim 13,
wherein the first memory device and the second memory device each comprises random access memory (RAM),
wherein the transmitting the dirty block map from the first memory controller to the second memory controller comprises:
transmitting the dirty block map from the first memory controller to the second memory controller using an interconnect protocol and without using any of the first computer processor or the second computer processor, and
wherein the copying the one or more dirty memory blocks from the first memory device to the second memory device comprises:
transmitting the one or more dirty memory blocks from the first memory device to the second memory device using the interconnect protocol and without using any of the first computer processor or the second computer processor.

15. The system of claim 13, wherein the triggering synchronization is performed by at least one of the first memory controller or the second memory controller.

16. The system of claim 13, the operations further comprising:
transmitting a reset signal from the second memory controller to the first memory controller;
based on receiving the reset signal, resetting the dirty block map at the first memory controller; and
determining that an epoch has passed, and in response triggering a second synchronization between the first memory controller and the second memory controller.

17. The system of claim 13, wherein each block of the dirty block map is sized based on a physical page size for the first memory device.

18. A computer program product comprising:
a computer-readable storage medium having computer-readable program code embodied therewith, the computer-readable program code executable by one or more computer processors to perform operations, comprising:
triggering synchronization between a first memory controller and a second memory controller,
wherein the first memory controller is associated with a first memory device and a first computer processor, and
wherein the second memory controller is associated with a second memory device and a second computer processor;
based on the triggering, transmitting a dirty block map from the first memory controller to the second memory controller, wherein the dirty block map identifies one or more dirty memory blocks, from among a plurality of memory blocks, associated with the first memory controller; and
copying the one or more dirty memory blocks from the first memory device to the second memory device based on the dirty block map.

19. The computer program product of claim 18,
wherein the first memory device and the second memory device each comprises random access memory (RAM),
wherein the transmitting the dirty block map from the first memory controller to the second memory controller comprises:
transmitting the dirty block map from the first memory controller to the second memory controller using an interconnect protocol and without using any of the first computer processor or the second computer processor, and
wherein the copying the one or more dirty memory blocks from the first memory device to the second memory device comprises:
transmitting the one or more dirty memory blocks from the first memory device to the second memory device using the interconnect protocol and without using any of the first computer processor or the second computer processor.

20. The computer program product of claim 18, wherein the triggering synchronization is performed by at least one of the first memory controller or the second memory controller.
